(19) United States
(12) Patent Application Publication
(10) Pub. No.: US 2006/0052146 A1
(43) Pub. Date: Mar. 9, 2006

(54) Heated mounted display device with mobile phone functions

(76) Inventor: Shu-Fong Ou, Taipei Hsien (TW)

Correspondence Address: Shu-Fong Ou, 235 Chung - Ho, Box 8-24, Taipei, TW

(21) Appl. No.: 10/936,403

(22) Filed: Sep. 9, 2004

(51) Int. Cl. H04M 1/00; H04B 1/38

(52) U.S. Cl. 455/575.2; 455/575.1; 455/566

(57) ABSTRACT

A head mounted display device with mobile phone functions comprises a transceiver for emitting and receiving wireless signals; an antenna connected to the transceiver for emitting or receiving signals; a digital content storage unit; a signal processing unit connected to the digital content storage unit for receiving signals from the digital content storage unit and then processing the received signals; a sound input unit for receiving input speeches and then converts the speeches into speech signals; a sound playing unit connected to the signal processing unit for emitting sound; an image display unit connected to the signal processing unit; the image display unit being installed in the head mounted display device for displaying the adjusted display image which is directly viewed by at least one eye of a user wearing the head mounted display. Thereby, the user can use the functions of the head mounted display and handset conveniently.

### FIELD OF THE INVENTION

The present invention relates to head mounted displays, and particular to a head mounted display device with mobile phone functions.

### BACKGROUND OF THE INVENTION

It is known that handsets are popular devices in current life. In the modern nations, almost everyone has at least one handset. In some cases for some peoples, they need to wear head mounted devices. For example, those having eye diseases possibly wear head mounted device to help to view images clearly. Or in many newly applications, some of which are in developing stages, the displays are made as head mounted devices so that the user can view the images, such as a movie, a web page, a document, etc. from the head mounted display directly. However, if one needs to wear a head mounted device, but he or she still needs to carry a handset, this will induce an inconvenient to the user. Especially, if the user wearing a head mounted display needs to use a handset, in most cases, he or she need take of the head mounted display to use the handset. Thereby, there is an eager demand of a novel device which can resolve the problem of the prior art.

Some prior arts discloses the head mounted device will be briefly description hereinafter as a reference.

In U.S. Pat. No. 6,369,952, a visual display device is provided for delivering a generated image, preferably combinable with environment light, to the eye of a user. A shroud protects from stray light and holds optical elements in desired alignment. An image generator is masked by at least two masks to provide for a high quality image without waste. A removably mounted shield or activatable device and convert the apparatus from a see-through device to an immersion device and back again. The device can be mounted to the user's head while still allowing for use of conventional eyeglasses. A tracker for outputting an indication of the orientation, attitude and/or position of a head-mounted display (HMD) may be provided. The tracker can be configured so that it is incorporated in the HMD housing and/or can be easily decoupled from the HMD, so that the HMD can be used without the tracker (e.g. for watching movies).

In U.S. Pat. No. 6,611,385, a wearable display system including a display panel to display a signal processed in a predetermined way. The wearable display system includes a grating to diffract a signal output from the display panel, a waveguide to guide the propagation of a signal diffracted by the grating; and a magnifying lens to magnify the signal propagating through the waveguide and to direct the signal toward an eye of a user. The waveguide is formed by a combination of two or more substrates. According to the wearable display system, optical devices are easily and simply arranged on the waveguide to conform to specifications, and furthermore, are individually manufactured and attached to the waveguide. Therefore, the wearable display system is manufactured with minimum time and effort.

In U.S. Pat. No. 5,991,084, a compact virtual image display system is provided, which includes a microdisplay; a first magnification optic consisting of three surfaces: a display input surface; a reflective/transmissive surface, and a reflective first magnification element surface; and a second magnification optic. Light forming the source object enters the first magnification optic at the display input surface. The light travels within the first magnification optic such that it is projected to an area on the reflective backslash transmissive surface that is at least partially within the full field of view provided by the second magnification optic. The light is directed to the reflective/transmissive surface at a first angle relative to the reflective/transmissive surface such that the light is internally reflected by the reflective/transmissive surface and directed to the reflective first magnification element surface. The first magnification element surface internally reflects the light corresponding to the source object as a magnified virtual image. The magnified virtual image is then is conveyed within the first magnification optic back to the reflective/transmissive surface at a second angle of incidence relative to the reflective/transmissive surface such that the light is transmitted by the reflective/transmissive surface out of the first magnification optic. The second magnification optic is positioned to receive the magnified virtual image transmitted from the first magnification optic and transmit a compound magnified virtual image of the magnified virtual image of the source object to the observer.

In U.S. Pat. No. 6,683,584, a camera display system displays information via a matrix display element mounted within a housing that is positioned relative to at least eye of a user. The display is connected to a video or image sensor such that the user can view information or images shown on the display. The display can be mounted to a housing so that the user can move the display in and out of the user's field of view.

In U.S. Pat. No. 6,680,802, a one-eye viewing type head-mounted image display device that is compact and comfortably wearable consists mainly of a viewer and an elastic member. The viewer includes an LCD, a main prism, a see-through prism, a frame, and a microphone. The main prism conducts an image, which is displayed on the LCD, to make the image viewable with either the user's right eye or left eye. The see-through prism is bonded to the main prism, transmits extraneously light, and conducts the light to a users eye. The frame bears the LCD at a predetermined position relative to the prisms. The microphone is mounted in the frame. The elastic member includes a nose rest which supports the viewer so that the viewer will be located at a predetermined position in front of the user's eye.

However, all above mentioned prior arts only disclose optical systems or mechanic structures for displaying image to the head mounted display, but no prior art discusses or discloses any structure or mechanism about the functions of handset to be installed to the head mounted display.

Moreover, no above mentioned prior art discloses any structure about the image quality to the eyes. Many people have eye diseases, such as far-sightedness (hyperopia), nearsightedness (shortsightedness; myopia), weak sight (amblyopia), or astigmatism, which cannot see clear views for normal images. Thereby, as a normally clean image is displayed on a head mounted unit, the image is vague to the eye-diseased user. This is because it is not imaged in the focus of the user. For example, the image of a nearsighted people is focused before the retina so that the people will see a vague image. For example, nearsighted people must wear a pair of eyeglasses to adjust the image clearness to make the image is just imaged on the retina. However, this problem is also occurred for the people wearing a head mounted display since in general, the user wearing a head mounted display can not further wear a pair of glasses. Thus, it is necessary that the image displayed on the head mounted display can provide images suitable for the eyes of the user. Thus it is necessary to that the images displayed on the head mount display is adjusted in advance so that as the image is incident in to the eyes it present a clear image on the retina of the user's eyes.

### SUMMARY OF THE INVENTION

Accordingly, the primary object of the present invention is to provide a head mounted display device with mobile phone functions, wherein the head mounted display device is installed with functions of handsets so that the user can share the functions of head mounted display and handset.

To achieve above objects, the present invention provides A head mounted display device with mobile phone functions comprises a transceiver for emitting and receiving wireless signals; an antenna connected to the transceiver for emitting or receiving signals; a digital content storage unit; a signal processing unit connected to the digital content storage unit for receiving signals from the digital content storage unit and then processing the received signals; a sound input unit for receiving input speeches and then converts the speeches into speech signals; a sound playing unit connected to the signal processing unit for emitting sound; an image display unit connected to the signal processing unit; the image display unit being installed in the head mounted display device for displaying the adjusted display image which is directly viewed by at least one eye of a user wearing the head mounted display. Thereby, the user can use the functions of the head mounted display and handset at the same time and conveniently.

The various objects and advantages of the present invention will be more readily understood from the following detailed description when read in conjunction with the appended drawing.

### BRIEF DESCRIPTION OF THE DRAWINGS

FIG. 1 shows a perspective view of head mounted display device with mobile phone functions of the present invention.

FIG. 2 is a block diagram about the head mounted display device with mobile phone functions of the present invention.

FIG. 3 shows the transceiver structure of the present invention.

FIG. 4 shows the receiver structure of the present invention.

FIG. 5 shows the transmitter structure of the present invention.

FIG. 6 is a block diagram of the present invention, where other auxiliary functions are added to the main structure illustrated in FIG. 1.

FIG. 7 is a block diagram about the component structure for adjusting focus according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

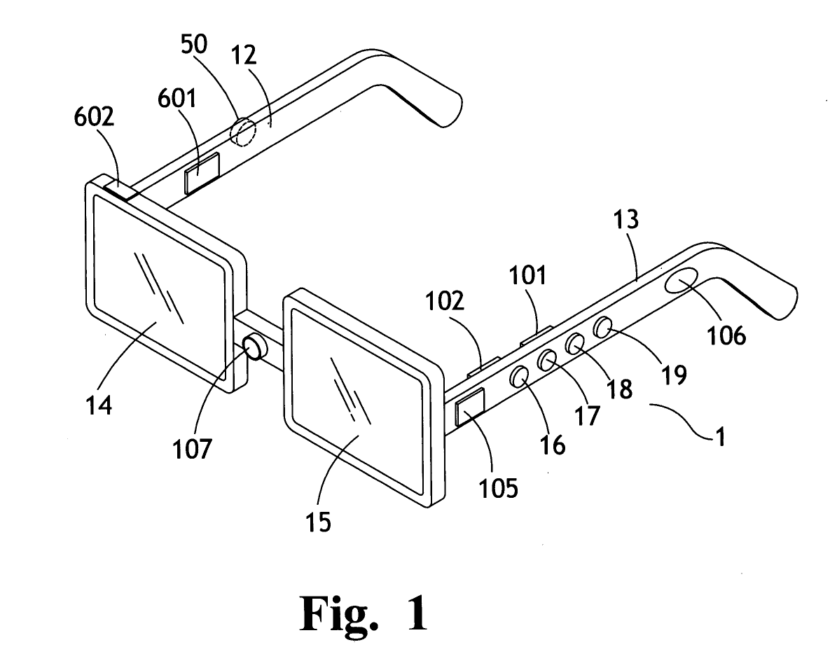

As depicted in FIG. 1, one embodiment about a head mounted display device I is displayed. The head mounted display device I can be realized as a pair of eyeglasses. The eyeglasses include a casing 1 and two temple pieces 12, and 13. The main components of the head mounted display device according to the present invention are mainly hidden in the casing. The casing 11 has two display screens 14, and 15 corresponding to the two eyes of the user wearing the eyeglasses.

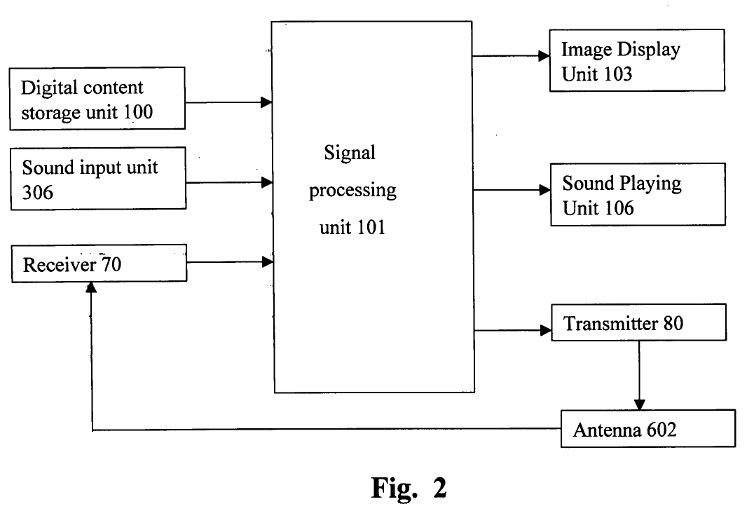

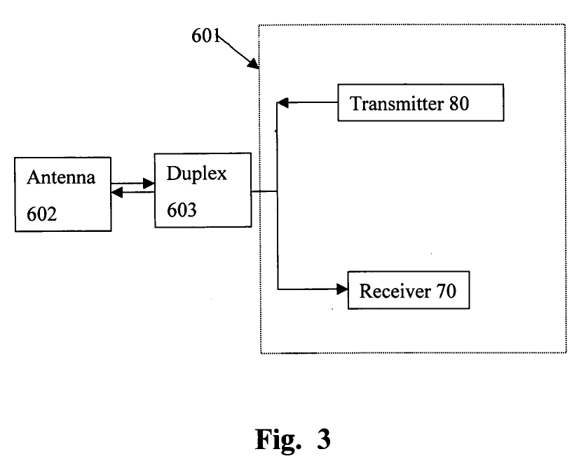

With reference to FIGS. 2 and 3, the system block diagram about the focus adjustable head mounted display system of the present invention is illustrated. The system includes a signal processing unit 101, an image display unit 103, a transceiver 601, a digital content storage device 100; a sound input unit 306; and a sound playing unit 106; an antenna 602.

The main feature of the present invention is that the present invention provides function of handsets, and thus modules used in handset are quipped in the present invention.

Referring to FIG. 3, the transceiver 601 includes a receiver 70 and a transmitter 80 for emitting and receiving wireless signals. In general, the transceiver 601 is an RF module for processing general base band signals into radio frequency signals for emitting or processing radio frequency signals into base band signals in the receiving processes.

Since the transceiver 601 is generally emitted signals with larger radiated power which is possible harmful to the users as it is used for a long time as it is placed near the head of the user, the transceiver can be made as an independent unit which is separated from the glasses of the head mounted device of the present invention.

The antenna 602 is connected to the transceiver 601 for emitting or receiving signals. As above description in the transceiver 601, the antenna is assembled with the transceiver 601 so that it can separate from the glasses of the head mounted unit.

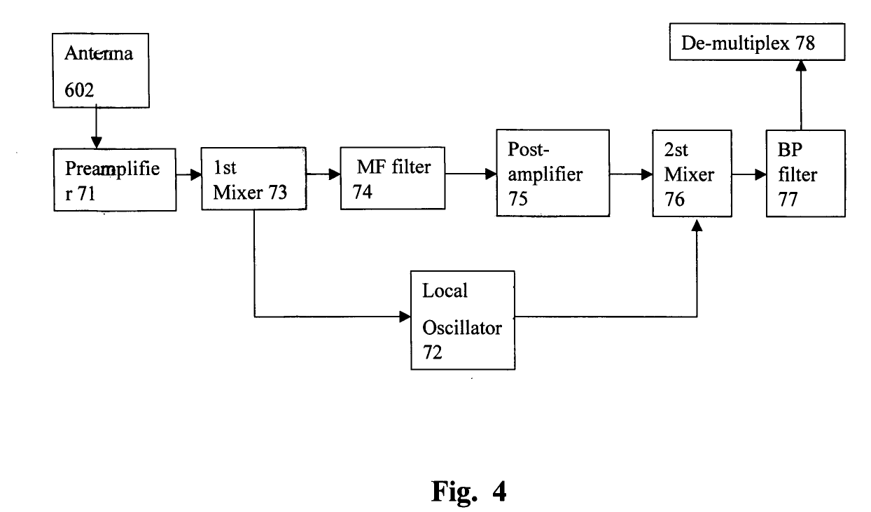

With reference to FIG. 4, one embodiment of the present invention about the details of the transceiver 601 is illustrated. It is illustrated that the receiver 70 includes the antenna 602, a preamplifier 71 for amplifying receiving signals from the antenna 602, a local oscillator 72 for providing oscillating signals; a first mixer 73 for receiving the oscillating signals from the local oscillator 72 so as to remove the frequency from the receiving signals; a middle frequency filter 74 for filtering the undesired noises from the receiving signals; a post amplifier 75 for amplifying the signals from the middle frequency filter 74 further; a secondary mixer 76 for further removing the mixing frequency from the receiving signals; a band pass filter 77 for filtering the noises from the transmitting signals further so as to get base band signal; and a demultiplexer 78 for de-multiplexing the receiving signals so as to get base band signals.

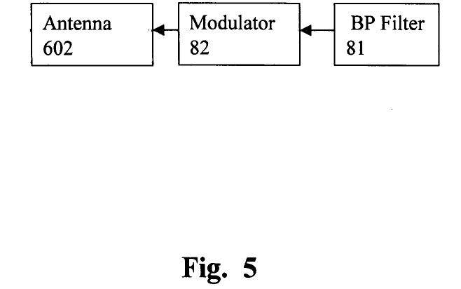

Referring to FIG. 5, the function block about one embodiment of the transmitter 80 of the present invention is illustrated. The transmitter 80 includes a band pass filter 81 which receives band pass signals for limiting the band pass signals as transmitting signals; a modulator 82 for upconverting the frequency of the transmitting signals so as to be emitted in a predetermined band; and then the signals are transmitted to the antenna 602.

With reference to FIG. 3, a duplex 603 may be placed before the antenna 602 for switching the receiver 70 and the transmitter 80.

The digital content storage unit 100 is a memory, such as DRAM, SRAM, Flash memory, etc. for storing software used in handset, such softwards for coding or decoding, etc. or other application software for the head mounted display device, such as digital data of movies, songs, books, letters, short messages, web pages, notes, programs, etc.

The signal processing unit 101 is connected to the digital content storage unit 100 for receiving image signals from the digital content storage unit 100 and then processing the received signals including image signals and non-image signals.

The sound input unit 306, for example, a microphone, serves for receiving speech inputs from a user.

The sound playing unit 106 is connected to the signal processing unit 101 for emitting sound, wherein the sound playing unit may be a microphone or one or a pair of earphone.

An image display unit 103 is connected to the signal processing unit 101. The image display unit 103 is installed in the head mounted display device for displaying the adjusted display image which is directly viewed by at least one eye of a user wearing the head mounted display.

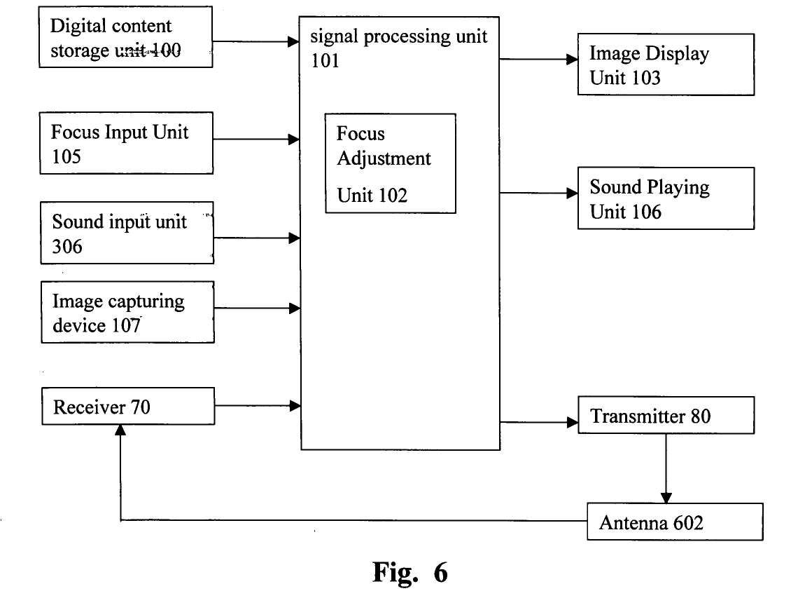

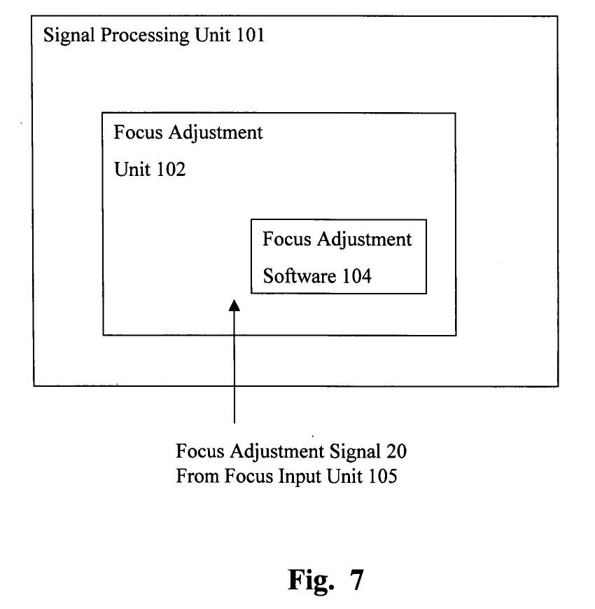

Furthermore, with reference to FIGS. 6 and 7, the present invention further comprises a focus adjustment unit 102 which is included in the signal processing unit 101 for adjusting an input image according an input focus adjustment signal 20 so that the adjusted display image responses the focus adjustment signal 20.

The focus input unit 105 connected to the focus adjustment unit 102. The focus input unit 105 is a manually operated device. The user can adjust the focus input unit 105 so as to generate the focus adjustment signal 20 to the signal processing unit 101. The focus input unit 105 provides a focus to the focus adjustment software 104.

With reference to FIG. 6, the present invention further comprises an image capturing device 107 for capturing environmental images. When the image is captured and is then inputted to the signal processing unit 101. It is displayed on the display screens 14, 15.

The focus adjustment unit 102 is included in the signal processing unit 101 for adjusting an input image according an input focus adjustment signal 20 so that the adjusted display image responses the focus adjustment signal 20.

Referring to FIG. 7, a focus adjustment software 104 is installed in the focus adjustment unit 102, see FIG. 3. The focus adjustment software 104 operates the input image so as to get the adjusted display image mapping to the input image with a designated focus from the focus adjustment signal 20.

It should be noted that in the present invention, the two display screens 14, 15 can present different image. For example, one display screen displays an image of a keyboard and another display screen displays an image of a normal monitor without keyboard image.

In some embodiments, it is useful to provide the user with controls. It is possible to provide controls which are not mounted on the head-mounted device (such as a remote control unit or a console) in the depicted embodiment. In the depicted embodiment, a button 16 is used to actuate the image focus adjustment signal 20 which give different focus values according to an input from the button 16. A button 17 is used to provide, for example, a mute function. Preferably, activation of this button provides for discontinuing display of the video image which is currently being output. Preferably, the mute control is configured so that the user can easily turn off at least the image, without requiring turning off of power to the HMD or interrupting the stream of data (although, in one embodiment, the mute button can be configured to simultaneously pause the data stream, such as by sending an interrupt command or other signal to a PC via the serial port). Moreover, a sound adjusting button 18 can be inclued in the present invention for adjusting the volume and other sound adjusting function.

Furthermore, a power actuation button 19 is provided for actuating the focus adjustable head mounted display system.

In operation, the user can adjust the button 16 to affect the focus input unit 105 to generate the focus adjustment signal 20 to the focus adjustment unit 102 so as to generate an adjusted display image. However, as the user finds that the adjusted display image is not clear. The user can further adjust the button 16 so as to generate another adjusted display image.

Referring to FIG. 1 again, in the embodiment of the present invention, the digital content storage unit 100, for example, a camera, is installed, preferably, in the center of the two display screen 14, 15 so as to capturing an image near a normal human view. The signal processing unit 101 is installed at the upper side of one lens, however, in the present invention, the signal processing unit 101 may be placed anywhere, for example, on the temple pieces 12, 13. Even the signal processing unit 101 is a separable piece separated from the eyeglasses. It is positioned not confined by those illustrated in the drawings.

The image display unit 103 may be a projecting type display unit, namely, the display image is generated and then is projected into the display screen 14, 15 so as to get a virtual image viewed by the user. Or the image display unit 103 is a direct display unit. Namely, the image is directly input to the lenses so as to present to the user. Further, the first button 16 is installed at one upper edge of one display screen 14 and the second button 17 is installed at one upper edge of another lenses 15. However, the positions of the first and second buttons 16, 17, 18, and 19 are not confined by those depicted in FIG. 1. They can be arranged in other place of the eyeglasses. All these are within the scope and spirit of the present invention.

Moreover, in the present invention, the focuses of the two eyes can be adjusted individually so as to match people having different eyesight at two eyes.

In another embodiment of the present invention, the image display unit 103 is a pair of eyeglasses. The lenses of the eyeglasses are both used as a display and a glass. In this embodiment, the button 17 serves for switching the focus adjustable head mounted display system of the present invention. As the button 17 is turned on, the focus adjustable head mounted display system will be actuated so as to actuate the digital content storage unit 100 and thus the image captured from the digital content storage unit 100 is processed and then displayed on the image display unit 103. When the button 17 is turned off, the focus adjustable head mounted display system of the present invention is turned off so that the eyeglasses are used as a normal eyeglass.

In another embodiment of the present invention, all the components are same as those in above said embodiment except that the lenses are replaced on display screens which has no function of eyeglass. Namely, the user only view the image inputted from the digital content storage unit 100.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A head mounted display device with mobile phone functions comprising:
a transceiver for emitting and receiving wireless signals;
an antenna connected to the transceiver for emitting or receiving signals;
a digital content storage unit;
a signal processing unit connected to the digital content storage unit for receiving signals from the digital content storage unit and then processing the received signals;
a sound input unit for receiving input speeches and then converts the speeches into speech signals;
a sound playing unit connected to the signal processing unit for emitting sound;
an image display unit connected to the signal processing unit; the image display unit being installed in the head mounted display device for displaying the adjusted display image which is directly viewed by at least one eye of a user wearing the head mounted display.

2. The head mounted display device with mobile phone functions as claimed in claim 1, further comprising:
a focus adjustment unit in the signal processing unit for adjusting an input image according to an input focus adjustment signal so that the adjusted display image responses the focus adjustment signal.

3. The head mounted display device with mobile phone functions as claimed in claim 2, further comprising:
a focus input unit connected to the focus adjustment unit; the focus input unit is a manually device for generating the focus adjustment signal to the signal processing unit; wherein the focus input unit provides a focus to the focus adjustment software.

4. The head mounted display device with mobile phone functions as claimed in claim 1, wherein a focus adjustment software is installed in the focus adjustment unit; the focus adjustment software operates images to be displayed to those wearing the head mounted display so as to get the adjusted display image mapping to the input image with a designated focus from the focus adjustment signal.

5. The head mounted display device with mobile phone functions as claimed in claim 1, wherein the digital content storage unit is a memory.

6. The head mounted display device with mobile phone functions as claimed in claim 1, wherein the transceiver is made as an independent unit.

7. The head mounted display device with mobile phone functions as claimed in claim 1, wherein the antenna is assembled with the transceiver so that it can separate from a body of the head mounted unit.

8. The head mounted display device with mobile phone functions as claimed in claim 1, wherein the receiver includes
the antenna,
a preamplifier for amplifying receiving signals from the antenna,
a local oscillator for providing oscillating signals;
a first mixer for receiving the oscillating signals from the local oscillator so as to remove the frequency from the receiving signals;
a middle frequency filter for filtering the noises from the receiving signals;
a post amplifier for amplifying the signals from the middle frequency filter;
a secondary mixer for further removing the mixing frequency from the receiving signals;
a band pass filter for filtering the noises from the transmitting signals further so as to get base band signal; and
a demultiplexer for de-multiplexing the receiving signals so as to get base band signals.

9. The head mounted display device with mobile phone functions as claimed in claim 1, wherein the transmitter includes
a band pass filter which receives band pass signals so as to limits the band pass signals as transmitting signals; and
a modulator for modulating the transmitting signals; and then the signals are transmitted to the antenna.

10. The head mounted display device with mobile phone functions as claimed in claim 1, wherein a duplex is placed before the antenna for switching the receiver and the transmitter.

11. The head mounted display device with mobile phone functions as claimed in claim 1, wherein the sound input unit is a microphone.

12. The head mounted display device with mobile phone functions as claimed in claim 1, wherein the sound playing unit is a speaker or one earphone or a pair of earphone.

13. The head mounted display device with mobile phone functions as claimed in claim 1, wherein the sound input unit is a microphone.

14. The head mounted display device with mobile phone functions as claimed in claim 1, further comprising an image capturing device for capturing environmental images which are then processed through the signal processing unit and then displayed on display screens.
